(19) United States
(12) Patent Application Publication
(10) Pub. No.: US 2021/0014457 A1
(43) Pub. Date: Jan. 14, 2021

(54) INFORMATION PROCESSING DEVICE, INFORMATION PROCESSING METHOD, AND PROGRAM

(71) Applicant: SONY CORPORATION, TOKYO (JP)

(72) Inventors: KENJI SUGIHARA, KANAGAWA (JP); MARI SAITO, KANAGAWA (JP)

(21) Appl. No.: 17/040,194

(22) PCT Filed: Jan. 29, 2019
(86) PCT No.: PCT/JP2019/002858

§ 371 Date: Sep. 22, 2020

(30) Foreign Application Priority Data
Mar. 30, 2018 (JP) 2018-069787

(51) Int. Cl. H04N 7/15; G06F 3/01; G06F 9/54; G06T 13/40

(52) U.S. Cl. CPC H04N 7/157; G06T 13/40; G06F 9/542; G06F 3/017

(57) ABSTRACT

There is a demand for provision of a technique that enables a user of a notification receiving side or a user of a notification transmitting side to easily understand the situation of his/her counterpart. Provided is an information processing device including: a first action-state acquisition unit configured to acquire first action-state information about an action state of a first user present at a first location; a second action-state acquisition unit configured to acquire a second action-state information about an action state of a second user present at a second location; an avatar control unit configured to gradually change, in accordance with the action state of the first user, a first avatar representing the first user, the first avatar being provided so as to be visible to the second user at the second location; an input determination unit configured to determine input about the first avatar based on the second action-state information; and a transmission unit configured to transmit a signal to a terminal of the first user present at the first location based on the input about the first avatar.

### FIELD

The present disclosure relates to an information processing device, an information processing method, and a program.

### BACKGROUND

Recently, various techniques are known as techniques to give a notification to a user. For example, in an assumable case, the timing that a user receives a notification is different depending on the situation of the user who receives the notification. Therefore, a technique that controls the timing of giving a notification to a user in accordance with the situation of the user who receives the notification has been disclosed (for example, see Patent Literature 1).

### CITATION LIST

### Patent Literature

Patent Literature 1: JP 2014-123192 A

### SUMMARY

### Technical Problem

However, it is important for the user of the notification receiving side or the user of the notification transmitting side to understand the situation of his/her counterpart. Therefore, there is a demand for provision of a technique that enables the user of the notification receiving side or the user of the notification transmitting side to easily understand the situation of his/her counterpart.

### Solution to Problem

According to the present disclosure, an information processing device is provided that includes: a first action-state acquisition unit configured to acquire first action-state information about an action state of a first user present at a first location; a second action-state acquisition unit configured to acquire a second action-state information about an action state of a second user present at a second location; an avatar control unit configured to gradually change, in accordance with the action state of the first user, a first avatar representing the first user, the first avatar being provided so as to be visible to the second user at the second location; an input determination unit configured to determine input about the first avatar based on the second action-state information; and a transmission unit configured to transmit a signal to a terminal of the first user present at the first location based on the input about the first avatar.

According to the present disclosure, an information processing method is provided that includes: acquiring first action-state information about an action state of a first user present at a first location; acquiring a second action-state information about an action state of a second user present at a second location; gradually changing, in accordance with the action state of the first user, a first avatar representing the first user, the first avatar being provided so as to be visible to the second user at the second location; determining input about the first avatar based on the second action-state information; and transmitting, by a processor, a signal to a terminal of the first user present at the first location based on the input about the first avatar.

According to the present disclosure, a program is provided that causes a computer to function as an information processing device including: a first action-state acquisition unit configured to acquire first action-state information about an action state of a first user present at a first location; a second action-state acquisition unit configured to acquire a second action-state information about an action state of a second user present at a second location; an avatar control unit configured to gradually change, in accordance with the action state of the first user, a first avatar representing the first user, the first avatar being provided so as to be visible to the second user at the second location; an input determination unit configured to determine input about the first avatar based on the second action-state information; and a transmission unit configured to transmit a signal to a terminal of the first user present at the first location based on the input about the first avatar.

### Advantageous Effects of Invention

As described above, according to the present disclosure, the technique that enables the user of the notification receiving side or the user of the notification transmitting side to easily understand the situation of his/her counterpart is provided. Note that the above described effects are not necessarily limitative, and any of the effects described in the present specification or other effects that are conceivable from this specification can be exerted in addition to or instead of the above described effects.

### BRIEF DESCRIPTION OF DRAWINGS

FIG. 1 is a diagram illustrating a configuration example of an information processing system according to an embodiment of the present disclosure.

FIG. 2 is a diagram illustrating an example of the correspondence relation between call time and notification levels.

FIG. 3 is a diagram illustrating an example of the correspondence relation between the factors to change an avatar and the notification levels.

FIG. 4 is a diagram illustrating a functional configuration example of a transmitting-side terminal.

FIG. 5 is a diagram illustrating a functional configuration example of a receiving-side terminal.

FIG. 6 is a diagram for illustrating an example of avatar control.

FIG. 7 is a flow chart illustrating an operation example of the transmitting-side terminal.

FIG. 8 is a flow chart illustrating an operation example of the receiving-side terminal.

FIG. 9 is a block diagram illustrating a hardware configuration example of an information processing device according to the embodiment of the present disclosure.

### DESCRIPTION OF EMBODIMENTS

Hereinafter, preferred embodiments of the present disclosure will be described in detail with reference to the accompanying drawings. In addition, in the present specification and drawings, constituent elements having substantially the same functional configurations are denoted by the same reference signs, and redundant description is omitted.

Furthermore, in the present specification and drawings, a plurality of constituent elements having substantially the same or similar functional configurations may be distinguished by the same reference signs followed by different numbers in some cases. However, if there is no particular need to mutually distinguish the plurality of constituent elements having substantially the same or similar functional configurations, they are denoted only by the same reference signs. Further, similar constituent elements in different embodiments may be distinguished by adding different alphabets after the same reference signs. However, if there is no need to particularly distinguish each of similar constituent elements, they are denoted only by the same reference signs.

Note that the description will be provided in the following order.

1. Overview

2. Details of embodiment 2.1. System configuration example 2.2. Correspondence relation between factors to change avatar and notification levels

2.3. Functional configuration example of transmitting-side terminal

2.4. Functional configuration example of receiving-side terminal

2.5. Details of functions of information processing system

3. Hardware configuration example

4. Conclusion

5. Modification examples

### 1. OVERVIEW

First, an overview of an embodiment of the present disclosure will be described. Recently, various techniques are known as techniques to give a notification to a user. For example, in an assumable case, the timing that a user receives a notification is different depending on the situation of the user who receives the notification. Therefore, a technique that controls the timing of giving a notification to a user in accordance with the situation of the user who receives the notification has been disclosed.

However, it is important for the user of the notification receiving side or the user of the notification transmitting side to understand the situation of his/her counterpart. For example, the user of the receiving side can estimate the urgency of the notification by understanding the action state of the user of the transmitting side. Alternatively, by understanding the action state of the user of the receiving side, the user of the transmitting side can estimate whether the user of the receiving side is likely to respond to the notification or not.

Therefore, an embodiment of the present disclosure will mainly describe a technique that enables the user of the notification receiving side or the user of the notification transmitting side to easily understand the situation of his/her counterpart. Specifically, the embodiment of the present disclosure mainly describes the technique that enables the user of the notification receiving side or the user of the notification transmitting side to understand the situation of his/her counterpart by an avatar that changes in accordance with the action state of the counterpart.

Hereinabove, the overview of the embodiment of the present disclosure has been described above.

### 2. DETAILS OF EMBODIMENT

Next, details of the embodiment of the present disclosure will be described.

[2.1. System Configuration Example]

First, a configuration example of an information processing system according to the embodiment of the present disclosure will be described.

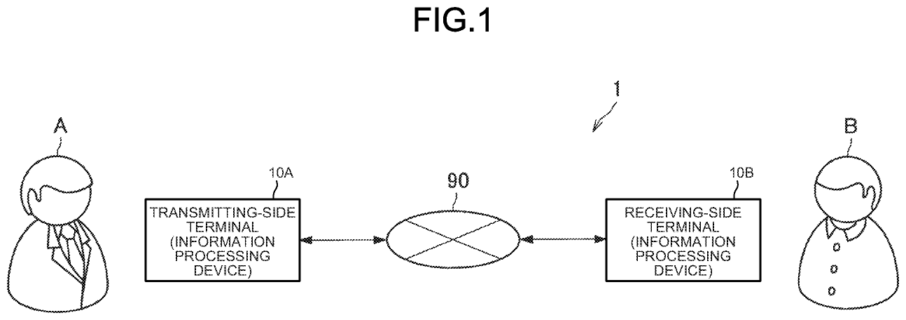

FIG. 1 is a diagram illustrating a configuration example of an information processing system according to the embodiment of the present disclosure. As illustrated in FIG. 1, an information processing system 1 has a transmitting-side terminal 10A and a receiving-side terminal 10B. The transmitting-side terminal 10A can be used by a user A. Meanwhile, the receiving-side terminal 10B can be used by a user B. The transmitting-side terminal 10A and the receiving-side terminal 10B are connected to a network 90 and are configured so that the terminals can communicate with each other via the network 90.

The transmitting-side terminal 10A is present at a location X. The user A is also present at the location X. Meanwhile, an avatar representing the user B (hereinafter, also simply referred to as “avatar of the user B”.) is present at the location X, and the avatar of the user B can be seen by the user A who is present at the location X. On the other hand, the receiving-side terminal 10B is present at a location Y. The user B is also present at the location Y. Meanwhile, an avatar representing the user A (hereinafter, also simply referred to as “avatar of the user A”.) is present at the location Y, and the avatar of the user A can be seen by the user B who is present at the location Y. Each of the location X and the location Y is only required to be a region which has some extent, and each of the location X and the location Y may be located anywhere. Note that, in the present disclosure, the location X may be referred to as a first location, the user A may be referred to as a first user, and the avatar of the user A may be referred to as a first avatar. Also, in the present disclosure, the location Y may be referred to as a second location, the user B may be referred to as a second user, and the avatar of the user B may be referred to as a second avatar.

In the embodiment of the present disclosure, a case in which the user A tries to have a talk with the user B is assumed. In that case, the user A carries out a notification initiation operation with respect to the transmitting-side terminal 10A. Note that a notification corresponds to calling, which is made before a talk is actually initiated, and “notification” is also referred to as “call” in the following description. Note that, in the present disclosure, various talking means such as voice talk and video talk can be used for talking. The notification initiation operation may be considered as a request transmitted from the user A for permission to initiate communication with the user B. Also, it may be considered that later-described change of the avatar of the user A is initiated in response to the permission request about communication initiation, which is transmitted from the terminal of the first user. Also, the notification initiation operation can correspond to an example of action states of the user A. When the transmitting-side terminal 10A detects a notification initiation operation, the transmitting-side terminal 10A initiates notification with respect to the receiving-side terminal 10B. Note that, in the present disclosure, the information about this action state of the user A is referred to as first action-state information in some cases. Similarly, in the present disclosure, the information about the action state of the user B is referred to as second action-state information in some cases. The first action-state information may include various information about the action state of the user A such as output signals of various sensors, which sense the action state of the user A, and determination results of the action state of the user A based on the output signals. The second action-state information may similarly include various information about the action state of the user B.

When the user B wants to initiate a talk with the user A, the user B carries out a notification response operation with respect to the receiving-side terminal 10B. When the receiving-side terminal 10B detects the notification response operation, the receiving-side terminal 10B establishes connection with the transmitting-side terminal 10A. As a result, a talk between the user A and the user B via the transmitting-side terminal 10A and the receiving-side terminal 10B is established, and the communication between the user A and the user B via the transmitting-side terminal 10A and the receiving-side terminal 10B is initiated. The notification response operation can correspond to an example of the action states of the user B.

Note that, in the embodiment of the present disclosure, a case in which communication between the user A and the user B is carried out by voice is assumed. However, the communication between the user A and the user B may be carried out by other contents (for example, video, etc.) instead of voice or in addition to voice.

Also, in the embodiment of the present disclosure, a case in which each of the transmitting-side terminal 10A and the receiving-side terminal 10B is a personal computer (PC) is mainly assumed. However, each of the transmitting-side terminal 10A and the receiving-side terminal 10B is not limited to a PC. For example, at least one of the transmitting-side terminal 10A and the receiving-side terminal 10B may be a television apparatus, may be a mobile phone, may be a tablet terminal, may be a smartphone, may be a wearable terminal (for example, a head-mounted display or the like), or may be a camera. Each of the transmitting-side terminal 10A and the receiving-side terminal 10B can function as an information processing device.

Hereinabove, the configuration example of the information processing system 1 according to the embodiment of the present disclosure has been described above.

[2.2. Correspondence Relation Between Factors to Change Avatar and Notification Levels]

Herein, a case in which a notification is given from the user A to the user B is assumed. If the notifications from the user A to the user B are the same regardless of urgency, the user B does not recognize a notification of high urgency or is bothered by a notification of low urgency. If the urgency which is defined in advance is used, the realistic situation of the user A or the user B is not reflected to the notification. Therefore, it is desirable that the urgency that fits the realistic situation of the user A or the user B be reflected to the notification.

For example, it is expected that the longer the elapsed time from initiation of the notification (hereinafter, also referred to as “call time”), the stronger the intention of the user A to tell the user B something, and it is therefore expected that urgency (hereinafter, also referred to as “notification level”.) is high. Hereinafter, the correspondence relation between the call time and the notification levels will be described.

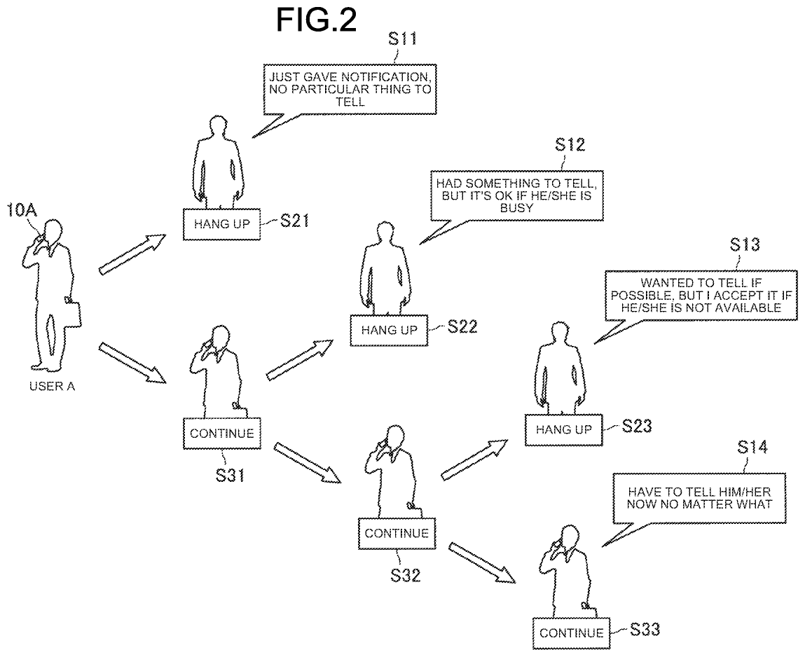

FIG. 2 is a diagram illustrating an example of the correspondence relation between call time and notification levels. Referring to FIG. 2, the user A who uses the transmitting-side terminal 10A is illustrated. Herein, a case in which the user A gives a notification to the user B is assumed. In this case, when a notification initiation operation carried out by the user A is detected, the transmitting-side terminal 10A initiates a notification to the receiving-side terminal 10B, which is used by the user B.

First, a case in which the user B does not respond (cannot respond) to the notification after first time (for example, after 10 seconds) from initiation of the notification is assumed. In this case, if the user A just gave the notification to the user B and does not have a particular thing to tell the user B (S11), the notification to the user B is cancelled (S21). On the other hand, if the user A has something to tell the user B, the user A continues the notification to the user B (S31).

Then, a case in which the user B does not respond to the notification even after second time (for example, after 30 seconds) from initiation of the notification is assumed. In this case, if the user A determines to give up the thing to tell the user B since the user B seems to be busy although the user A had something to tell the user B (S12), the user A cancels the notification to the user B (S22). On the other hand, if the user A cannot give up the thing to tell the user B, the user A continues the notification to the user B (S32).

Then, a case in which the user B does not respond to the notification even after third time (for example, after 1 minute) from initiation of the notification is assumed. In this case, the user A wanted to tell the user B the thing if possible but determined to give up since it seems the user B was unable to respond to the notification (S13), the user A cancels the notification to the user B (S23). On the other hand, if the user A determines to tell the user B the thing, which involves the user B, now no matter what, the user A continues the notification to the user B (S33).

As described with reference to FIG. 2, it is expected that the longer the call time, the stronger the intention of the user A to tell the user B the thing, and a high notification level is expected. Therefore, it is desired that the higher the notification level, the more noticeable for the user B the notification to the user B is. In this regard, the notification to the user B may be gradually changed to more noticeable notifications. The embodiment of the present disclosure assumes a case in which the change of the notification to the user B is the change of the avatar of the user A, which can be seen by the user B.

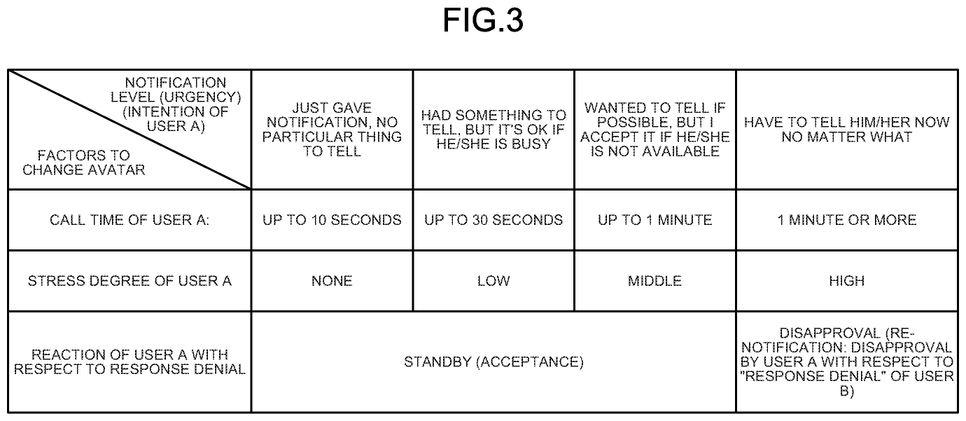

FIG. 3 is a diagram illustrating an example of the correspondence relation between the factors to change the avatar and the notification levels. Referring to FIG. 3, an example of the correspondence relation between the call time and the notification levels is illustrated as an example of the factors to change the avatar of the user A. The correspondence relation between the call time and the notification levels is as described with reference to FIG. 2. Also, referring to FIG. 3, an example of the correspondence relation between the stress degrees of the user A and the notification levels is illustrated as an example of the factors to change the avatar of the user A.

As illustrated in FIG. 3, it is expected that the higher the stress degree of the user A, the stronger the intention of the user A to tell the user B the thing, and a high notification level is therefore expected. Note that the stress degree of the user A may be detected in any way. For example, the stress degree of the user A may be estimated/acquired based on an image recognition result with respect to an image of the user A, which is captured by an imaging device, or the stress degree of the user A may be estimated/acquired based on biological information sensed from the user A by a biological sensor.

Hereinabove, the example of the correspondence relation between the factors to change the avatar and the notification levels has been described.

[2.3. Functional Configuration Example of Transmitting-Side Terminal]

Subsequently, a functional configuration example of the transmitting-side terminal 10A will be described.

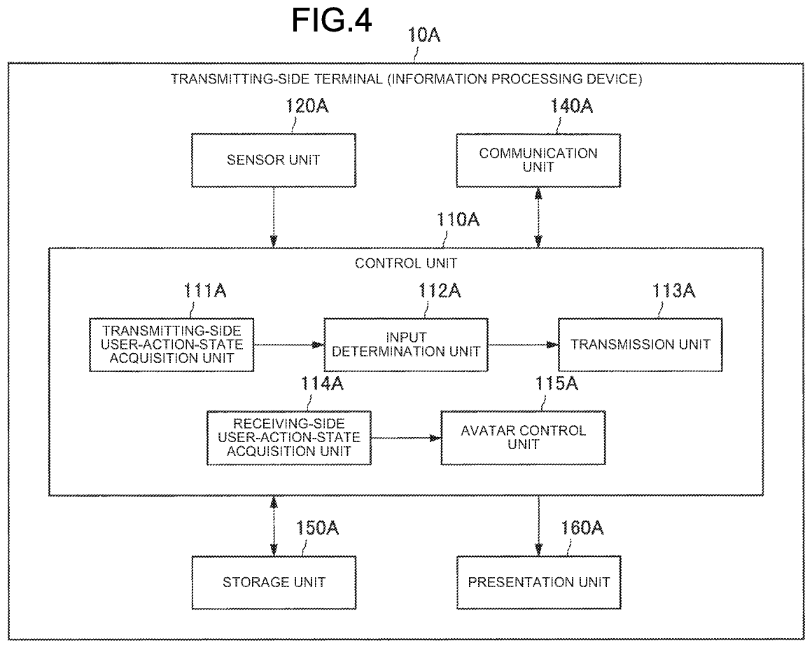

FIG. 4 is a diagram illustrating the functional configuration example of the transmitting-side terminal 10A. As illustrated in FIG. 4, the transmitting-side terminal 10A has a control unit 110A, a sensor unit 120A, a communication unit 140A, a storage unit 150A, and a presentation unit 160A. Hereinafter, these functional blocks provided in the transmitting-side terminal 10A will be described.

The control unit 110A may include, for example, a processing device(s) such as one or a plurality of central processing units (CPUs; central arithmetic processing device). If these blocks include a processing device such as CPU, the processing device may include an electronic circuit. The control unit 110A can be realized by executing a program by such a processing device.

The control unit 110A has a transmitting-side user-action-state acquisition unit 111A, an input determination unit 112A, a transmission unit 113A, a receiving-side user-action-state acquisition unit 114A, and an avatar control unit 115A. The transmitting-side user-action-state acquisition unit 111A can correspond to an example of a second action-state acquisition unit. Also, the receiving-side user-action-state acquisition unit 114A can correspond to an example of a first action-state acquisition unit. Detailed functions of these blocks will be described later.

The sensor unit 120A has various sensors and detects various sensing data by the various sensors. More specifically, the sensor unit 120A detects the voice emitted by the user A and the state of the user A. The state of the user A can include the action state of the user A. The sensor unit 120A may be provided at an arbitrary location of the transmitting-side terminal 10A.

The embodiment of the present disclosure assumes a case in which the sensor unit 120A includes a microphone and an imaging device. Moreover, it assumes the case that the voice emitted by the user A is detected by the microphone and that the voice emitted by the user A is used for communication. However, instead of the voice emitted by the user A or in addition to the voice emitted by the user A, video capturing the user A by the imaging device may be used for the communication.

Moreover, the embodiment of the present disclosure assumes the case in which the state of the user A is detected by the imaging device. However, the state of the user A may be detected by a sensor(s) other than the imaging device. For example, if the transmitting-side terminal 10A is a wearable terminal, the state of the user A may be detected by a sensor(s) of the wearable terminal (for example, an acceleration sensor, a gyroscope sensor, a vibration sensor, a global positioning system (GPS) sensor, etc.).

The communication unit 140A includes a communication circuit and has a function to communicate with the receiving-side terminal 10B via the network 90. For example, the communication unit 140A has a function to acquire data from the receiving-side terminal 10B and provide data to the receiving-side terminal 10B. For example, if the notification initiation operation carried out by the user A is detected by the sensor unit 120A, the communication unit 140A transmits a notification to the receiving-side terminal 10B via the network 90. Also, if a notification response is received from the receiving-side terminal 10B via the network 90, the communication unit 140A establishes connection with the receiving-side terminal 10B via the network 90. Then, when voice emitted by the user A is detected by the microphone, the communication unit 140A transmits the voice to the receiving-side terminal 10B.

The storage unit 150A is a recording medium that includes a memory, stores a program executed by the control unit 110A, and stores data necessary for executing the program. Also, the storage unit 150A temporarily stores data for computing, which is carried out by the control unit 110A. For example, the storage unit 150A includes a magnetic storage-unit device, a semiconductor storage device, an optical storage device, or a magneto-optical storage device.

The presentation unit 160A presents various information to the user A. The embodiment of the present disclosure assumes the case in which the presentation unit 160A has a display and a speaker. In this case, the type of the display is not limited. For example, the display may be a liquid crystal display, an organic electro-luminescence (EL) display, or a projector which can carry out projection on a wall or the like. Alternatively, the display may be a light such as a light-emitting diode (LED).

Specifically, the embodiment of the present disclosure assumes the case in which the avatar of the user B is a virtual object and assumes the case in which the display shows the avatar of the user B. However, the avatar of the user B may be a real object. The real object may be, for example, a mobile object having a drive mechanism. More specifically, various forms such as a mobile object having rollers, wheels, or tires, a two-legged robot, a four-legged robot, etc. can be employed. In such a case, the autonomous mobile object can form an independent information processing device. In such a case, the presentation unit 160A is not required to have a display. Meanwhile, when the voice emitted by the user B is received from the receiving-side terminal 10B via the network 90 after the connection with the receiving-side terminal 10B is established by the communication unit 140A, the speaker outputs the voice. The voice output by the speaker is perceived by the auditory sense of the user A.

Note that, the embodiment of the present disclosure mainly assumes the case in which the control unit 110A, the sensor unit 120A, the communication unit 140A, the storage unit 150A, and the presentation unit 160A are present in the transmitting-side terminal 10A. However, at least one of the control unit 110A, the sensor unit 120A, the communication unit 140A, the storage unit 150A, and the presentation unit 160A may be present outside the transmitting-side terminal 10A.

Hereinabove, the functional configuration example of the transmitting-side terminal 10A according to the embodiment of the present disclosure has been described.

[2.4. Functional Configuration Example of Receiving-Side Terminal]

Subsequently, a functional configuration example of the receiving-side terminal 10B will be described.

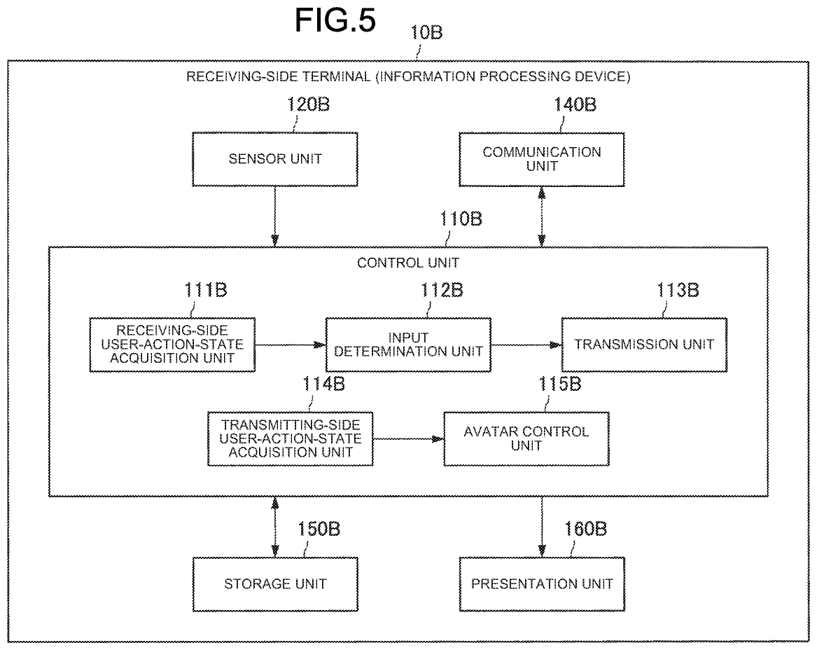

FIG. 5 is a diagram illustrating the functional configuration example of the receiving-side terminal 10B. As illustrated in FIG. 5, the receiving-side terminal 10B has a control unit 110B, a sensor unit 120B, a communication unit 140B, a storage unit 150B, and a presentation unit 160B. Hereinafter, these functional blocks provided in the receiving-side terminal 10B will be described.

The control unit 110B may include, for example, a processing device(s) such as one or a plurality of central processing units (CPUs; central arithmetic processing device). If these blocks include a processing device such as CPU, the processing device may include an electronic circuit. The control unit 110B can be realized by executing a program by such a processing device.

The control unit 110B has a receiving-side user-action-state acquisition unit 111B, an input determination unit 112B, a transmission unit 113B, a transmitting-side user-action-state acquisition unit 114B, and an avatar control unit 115B. The receiving-side user-action-state acquisition unit 111B can correspond to an example of the second action-state acquisition unit. Also, the transmitting-side user-action-state acquisition unit 114B can correspond to an example of the first action-state acquisition unit. Detailed functions of these blocks will be described later.

The sensor unit 120B has various sensors and detects various sensing data by the various sensors. More specifically, the sensor unit 120B detects the voice emitted by the user B and the state of the user B. The state of the user B can includes the action state of the user B. The sensor unit 120B may be provided at an arbitrary location of the receiving-side terminal 10B.

The embodiment of the present disclosure assumes a case in which the sensor unit 120B includes a microphone and an imaging device. Moreover, it assumes the case that the voice emitted by the user B is detected by the microphone and that the voice emitted by the user B is used for communication. However, instead of the voice emitted by the user B or in addition to the voice emitted by the user B, video capturing the user B by the imaging device may be used for the communication.

Moreover, the embodiment of the present disclosure assumes the case in which the state of the user B is detected by the imaging device. However, the state of the user B may be detected by a sensor(s) other than the imaging device. For example, if the receiving-side terminal 10B is a wearable terminal, the state of the user B may be detected by a sensor(s) of the wearable terminal (for example, an acceleration sensor, a gyroscope sensor, a vibration sensor, a global positioning system (GPS) sensor, etc.).

The communication unit 140B includes a communication circuit and has a function to communicate with the transmitting-side terminal 10A via the network 90. For example, the communication unit 140B has a function to acquire data from the transmitting-side terminal 10A and provide data to the transmitting-side terminal 10A. For example, if a notification response operation, which is carried out by the user B, is detected by the sensor unit 120B, the communication unit 140B transmits a notification response to the transmitting-side terminal 10A via the network 90 and establishes connection with the transmitting-side terminal 10A via the network 90. Then, when voice emitted by the user B is detected by the microphone, the communication unit 140B transmits the voice to the transmitting-side terminal 10A. Moreover, the communication unit 140B receives a notification from the transmitting-side terminal 10A via the network 90.

The storage unit 150B is a recording medium that includes a memory, stores a program executed by the control unit 110B, and stores data necessary for executing the program. Also, the storage unit 150B temporarily stores data for computing, which is carried out by the control unit 110B. For example, the storage unit 150B includes a magnetic storage-unit device, a semiconductor storage device, an optical storage device, or a magneto-optical storage device.

The presentation unit 160B presents various information to the user B. The embodiment of the present disclosure assumes the case in which the presentation unit 160B has a display and a speaker. In this case, the type of the display is not limited. For example, the display may be a liquid crystal display, an organic electro-luminescence (EL) display, or a projector which can carry out projection on a wall or the like. Alternatively, the display may be a light such as a light-emitting diode (LED).

Specifically, the embodiment of the present disclosure assumes the case in which the avatar of the user A is a virtual object and assumes the case in which the display shows the avatar of the user A. However, the avatar of the user A may be a real object (for example, a robot or the like). In such a case, the presentation unit 160B is not required to have a display. Meanwhile, when the voice emitted by the user A is received from the transmitting-side terminal 10A via the network 90 after the connection with the transmitting-side terminal 10A is established by the communication unit 140B, the speaker outputs the voice. The voice output by the speaker is perceived by the auditory sense of the user B.

Note that, the embodiment of the present disclosure mainly assumes the case in which the control unit 110B, the sensor unit 120B, the communication unit 140B, the storage unit 150B, and the presentation unit 160B are present in the receiving-side terminal 10B. However, at least one of the control unit 110B, the sensor unit 120B, the communication unit 140B, the storage unit 150B, and the presentation unit 160B may be present outside the receiving-side terminal 10B.

Hereinabove, the functional configuration example of the receiving-side terminal 10B according to the embodiment of the present disclosure has been described.

[2.5. Details of Functions of Information Processing System]

Subsequently, details of functions of the information processing system 1 will be described.

In the embodiment of the present disclosure, in the transmitting-side terminal 10A (of the user A present at the location X), the sensor unit 120A obtains the information about the action state of the user A by sensing. The action states of the user A can include initiation of notification, continuance of notification, end of notification, re-notification, etc. Note that the sensor unit 120A may be, for example, a sensor which acquires image information or depth information of the user A. The input determination unit 112A determines the input about the avatar representing the user B based on the information about the action state of the user A. The input about the avatar representing the user B can include initiation of notification, continuance of notification, end of notification, re-notification, etc. Based on the input about the avatar representing the user B, the transmission unit 113A transmits a signal (signal for controlling the avatar A) to the receiving-side terminal 10B.

In the receiving-side terminal 10B (of the user B present at the location Y), the communication unit 140B receives the information about the action state of the user A (signal for controlling the avatar A) via the network 90. The transmitting-side user-action-state acquisition unit 114B acquires the information about the action state of the user A. The avatar control unit 115B gradually changes the avatar A representing the user A in accordance with the action state of the user A. The avatar which is changed in accordance with the action state of the user A enables the user B to easily understand the situation of the user A.

On the other hand, the sensor unit 120B obtains information about the action state of the user B by sensing. The action state of the user B includes, for example, whether he/she has noticed the notification and whether he/she has responded to the notification. Note that the sensor unit 120B may be, for example, a sensor which acquires image information or depth information of the user B. The input determination unit 112B determines the input about the avatar representing the user A based on the information about the action state of the user B. The input about the avatar representing the user A includes, for example, whether he/she has noticed the notification and whether he/she has responded to the notification. Based on the input about the avatar representing the user A, the transmission unit 113B transmits a signal (signal for controlling the avatar B) to the transmitting-side terminal 10A. Note that it may be considered that the transmission unit 113B transmits a first signal, which indicates initiation of communication, to the transmitting-side terminal 10A based on first input and transmits a second signal, which indicates non-permission of initiation of communication, to the transmitting-side terminal 10A based on second input. Also, it may be considered that the transmission unit 113B is for transmitting the signal indicating the action state of the user B to the transmitting-side terminal 10A of the user A. As described later, the transmission unit 113B can change the signal indicating the action state of the user B based on the input of the user B about the avatar A. Note that the signal transmitted by the transmission unit 113B may be considered as the signal which controls the avatar B controlled by the transmitting-side terminal 10A. The signal transmitted by the transmission unit 113B may be the signal which directly controls the avatar B. Alternatively, the signal transmitted by the transmission unit 113B may be converted to the signal, which controls the avatar B, through processing by the network 90. Alternatively, the signal transmitted by the transmission unit 113B may be converted to the signal, which controls the avatar B, through processing by the transmitting-side terminal 10A.

In the transmitting-side terminal 10A, the communication unit 140A receives the information about the action state of the user B (signal for controlling the avatar B) via the network 90. The receiving-side user-action-state acquisition unit 114A acquires the information about the action state of the user B. The avatar control unit 115A gradually changes the avatar B representing the user B in accordance with the action state of the user B. The avatar which is changed in accordance with the action state of the user B enables the user A to easily understand the situation of the user B.

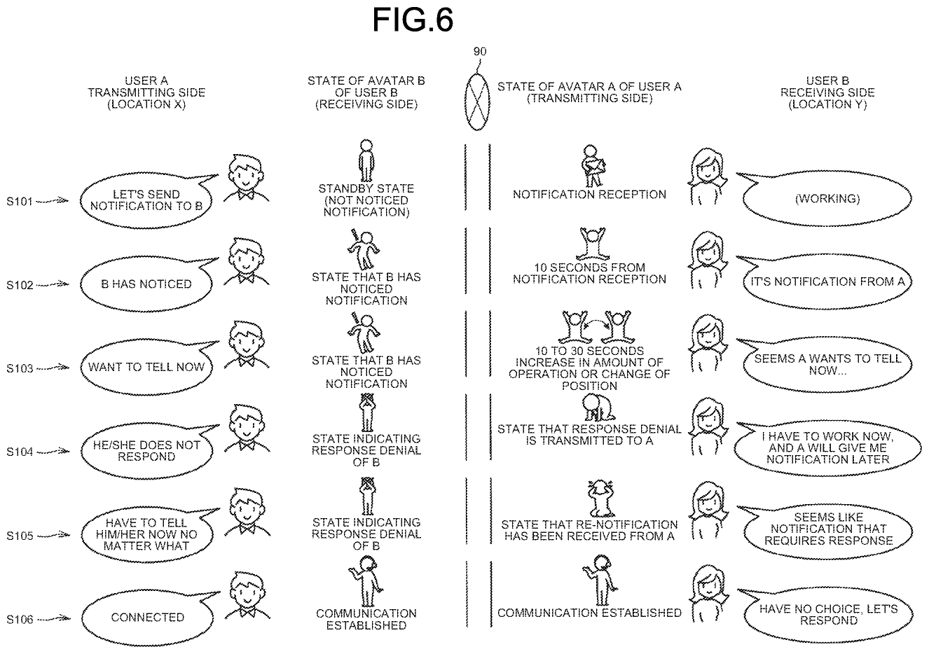

Herein, an example of avatar control will be described. FIG. 6 is a diagram for illustrating the example of avatar control. As illustrated in FIG. 6, the transmitting-side user A is present at the location X. At the location X, the sensor unit 120A can detect various interactions carried out by the user A (with respect to the avatar B). On the other hand, the receiving-side user B is present at the location Y. At the location Y, the sensor unit 120B can detect various interactions carried out by the user B (with respect to the avatar A).

In S101, a state in which the user A talks to the avatar B, which is present at the location X and represents the state of the user B, is illustrated. Note that the state (operation, action) of the user A is determined by the sensor unit 120A present at the location X. As a result, the notification (call) from the user A to the user B is initiated, the initiation of notification is acquired by the transmitting-side user-action-state acquisition unit 114B, and the state of the avatar A, which is present at the location Y and represents the state of the user A, is changed by the avatar control unit 115B to the state indicating reception of the notification from the user A.

In S102, the fact that the user B has noticed the notification from the user A is determined by the sensor unit 120B, which is present at the location Y, like the location X. For example, whether the user B has noticed the notification or not may be determined by whether the line of sight of the user B meets the avatar A or not. The fact that the user B has noticed the user A contacting him/her is acquired by the receiving-side user-action-state acquisition unit 114A via the network 90, and the user A is notified of this by operation of the avatar B in accordance with the control carried out by the avatar control unit 115A. Note that the second input in the present disclosure may be considered to include “the fact that the user B has noticed the notification from the user A”.

In S103, in accordance with control by the avatar control unit 115B, the operation or the position of the avatar A present at the location Y is changed in accordance with the notification level. For example, the avatar A moves to a range of higher noticeability for the user B and/or increases the amount of operation. More specifically, the avatar A may move to a position between an object on which the user B is working and the user B to disturb the work (task) of the user B.

In S104, illustrated is a state in which the fact that the user A has continued the call is acquired by the transmitting-side user-action-state acquisition unit 114B, and the avatar A has operated to gradually indicate the notification intention of the user A in accordance with the control carried out by the avatar control unit 115B, but the user B who has noticed the notification did not initiate communication. In accordance with the control carried out by the avatar control unit 115A, the avatar B is correspondingly changed to the state indicating communication denial (response denial) of the user B. On the other hand, the avatar A may be changed in accordance with the control carried out by the avatar control unit 115B so as to indicate that the user A has been disappointed to show the fact that the response denial has been transmitted from the user B to the user A.

In S105, illustrated is a state in which, although response denial of the user B has been confirmed, the user A has continued the notification (re-notification) with respect to the user B. When the continuance of the notification is received by the communication unit 140B and acquired by the transmitting-side user-action-state acquisition unit 114B, the avatar A can be changed in accordance with the control carried out by the avatar control unit 115B so as to indicate higher urgency.

In S106, illustrated is a state in which, in response to the change of the avatar A, the user B has finally initiated communication with the user A. As well as the initiation of notification at the location X, this communication may be initiated by being detected by the sensor unit 120A the fact that the user B has talked to the avatar A. Note that the input determination unit 112B may determine the fact that the user B has initiated communication based on image information or depth information indicating that the user B has carried out a particular gesture. On the other hand, the input determination unit 112B may determine the fact that the user B has noticed the notification or the fact that the user B has done response denial based on the image information or the depth information of the user B indicating that the user B has not carried out a particular gesture. Such a particular gesture may be, for example, a gesture that the hand of the user B gets close to his/her face, more specifically, a gesture that the hand of the user B becomes adjacent to his/her face. The adjacence of the hand and the face can be determined by whether the distance between the hand and the face is within a predetermined value or not. Note that, more specifically, the particular gesture may be a gesture in which the hand and the ear of the user B becomes adjacent to each other, in other words, generally, a gesture in which a receiver is caused to abut the ear. Note that, the input determination unit 112B may determine the fact that the user B has noticed the notification based on the direction or sight-line information of the user B based on the image information or the depth information of the user B and may determine initiation of communication based on voice information of the user B. According to this configuration, the user B can control the initiation of communication with the user A by a natural operation without doing a particular gesture. In this manner, the input determination unit 112B may be considered to determine the input about the avatar A based on the intentional input (first input) and relatively unintentional input (second input) of the user B.

Hereinabove, the example of avatar control has been described above.

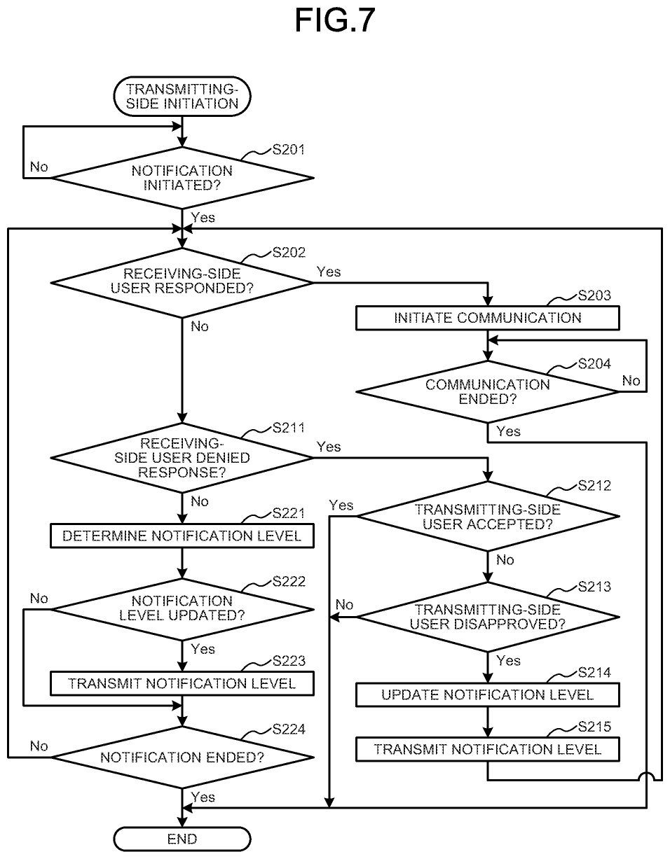

FIG. 7 is a flow chart illustrating an operation example of the transmitting-side terminal 10A. With reference to FIG. 7, the operation example of the transmitting-side terminal 10A will be described. As illustrated in FIG. 7, if a notification initiation operation by the user A is not detected by the sensor unit 120A and a notification by the communication unit 140A is not initiated (“No” in S201), S201 is repeatedly executed. On the other hand, if a notification initiation operation by the user A is detected by the sensor unit 120A and a notification by the communication unit 140A is initiated (“Yes” in S201), operation undergoes a transition to S202.

If the receiving-side user B responds to the notification, the response is received by the communication unit 140A, and the response is acquired by the receiving-side user-action-state acquisition unit 114A (“Yes” in S202), the communication unit 140A establishes connection with the receiving-side terminal 10B. As a result, the communication unit 140A initiates communication between the user A and the user B (S203). In this process, the avatar control unit 115A controls the avatar B so as to indicate the initiation of communication.

If the fact that the transmitting-side user A is continuing the communication is detected by the sensor unit 120A and is acquired by the transmitting-side user-action-state acquisition unit 111A (“No” in S204), S204 is repeatedly executed. On the other hand, if the fact that the transmitting-side user A has ended the communication is detected by the sensor unit 120A and is acquired by the transmitting-side user-action-state acquisition unit 111A (“Yes” in S204), the operation of the transmitting-side terminal 10A ends.

In a case in which the receiving-side user B does not respond to the notification (“No” in S202) and does not carry out response denial either (“No” in S211), if the fact that the user B has not noticed the notification is acquired by the receiving-side user-action-state acquisition unit 111B, the avatar control unit 115A controls the avatar B to indicate the fact that the user B has not noticed the notification.

Then, the transmitting-side user-action-state acquisition unit 111A determines the notification level (S221). The notification level is an example of the information about the action state of the user A and can be estimated/acquired based on the call time or the stress degree of the user A as described above. If the notification level is not updated (“No” in S222), the operation may undergo transition to S224. On the other hand, if the notification level is updated (“Yes” in S222), the transmission unit 113A transmits the updated notification level to the receiving-side terminal 10B (S223), and the process proceeds to S224.

Note that the update may be carried out so that the longer the call time, the higher the notification level, or the update may be carried out so that the higher the stress degree of the user A, the higher the notification level. Alternatively, the update may be carried out so that the notification level is increased if a particular gesture carried out by the user A is detected. However, the update may be carried out so as to lower the notification level. For example, the update may be carried out so as to lower the notification level if the fact that the transmitting-side user A has initiated a particular action other than the communication with the user B is detected or if a particular voice of the user A is detected.

Therefore, in order to cause the user A to understand the current notification level, the current notification level can be presented to the user A by the presentation unit 160A. The current notification level may be presented to the user A in any way. The current notification level may be displayed by a numerical value by the display. Alternatively, animation accompanied by the expression corresponding to the current notification level (for example, calling animation) may be displayed by the display. Alternatively, the user A can set a configuration so as not to update the notification level.

If a notification end operation by the user A is not detected by the sensor unit 120A (“No” in S224), the operation undergoes transition to S202. On the other hand, if a notification end operation by the user A is detected by the sensor unit 120A (“Yes” in S224), the operation ends.

If response denial is received by the communication unit 140A and the response denial is acquired by the receiving-side user-action-state acquisition unit 114A (“Yes” in S211), the avatar control unit 115A controls the avatar B so as to indicate the response denial. Note that, as described later, levels indicating the intensity of denial (hereinafter, also referred to as “denial levels”) may be provided for the response denial. In this process, the avatar control unit 115A may control the avatar B so that a different state is provided depending on the denial level.

If acceptance by the user A with respect to the response denial is acquired by the transmitting-side user-action-state acquisition unit 111A (“Yes” in S212), the operation ends. On the other hand, if acceptance by the user A with respect to the response denial is not acquired by the transmitting-side user-action-state acquisition unit 111A (“No” in S212) and if disapproval by the user A with respect to the response denial is not acquired either (“No” in S213), the operation ends.

On the other hand, if disapproval by the user A with respect to the response denial is acquired by the transmitting-side user-action-state acquisition unit 111A (“Yes” in S213), the notification level is updated (S214), the transmission unit 113A transmits the updated notification level to the receiving-side terminal 10B (S215), and the operation undergoes transition to S202. The update of the notification level is as described above.

Hereinabove, the operation example of the transmitting-side terminal 10A has been described.

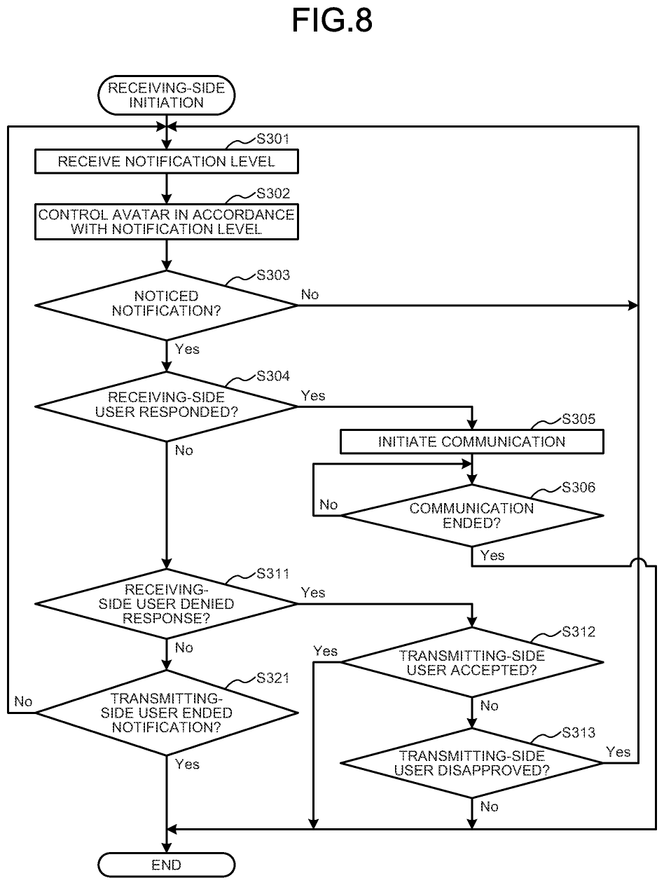

FIG. 8 is a flow chart illustrating an operation example of the receiving-side terminal 10B. With reference to FIG. 8, the operation example of the receiving-side terminal 10B will be described. As illustrated in FIG. 8, if a notification level is received by the communication unit 140B from the transmitting-side terminal 10A via the network 90, the notification level is acquired by the transmitting-side user-action-state acquisition unit 114B, and the avatar A is controlled (the avatar A is changed) by the avatar control unit 115B in accordance with the notification level (S302).

If the fact that the user B has not noticed the notification (in other words, change of the avatar A) is detected by the sensor unit 120B and is acquired by the receiving-side user-action-state acquisition unit 111B (“No” in S303), the operation undergoes transition to S301. On the other hand, if the fact that the user B has noticed the notification is detected by the sensor unit 120B and is acquired by the receiving-side user-action-state acquisition unit 111B (“Yes” in S303), the operation undergoes transition to S204.

Subsequently, if the fact that the receiving-side user B has responded to the notification is detected by the sensor unit 120B and is acquired by the receiving-side user-action-state acquisition unit 111B (“Yes” in S304), the communication unit 140B establishes connection with the transmitting-side terminal 10A. As a result, the communication unit 140B initiates communication between the user A and the user B (S305). In this process, the avatar control unit 115B controls the avatar A so as to indicate the initiation of communication.

If the fact that the receiving-side user B is continuing the communication is detected by the sensor unit 120B and is acquired by the receiving-side user-action-state acquisition unit 111B (“No” in S306), S306 is repeatedly executed. On the other hand, if the fact that the receiving-side user B has ended the communication is detected by the sensor unit 120B and is acquired by the receiving-side user-action-state acquisition unit 111B (“Yes” in S306), the operation of the receiving-side terminal 10B ends. If the receiving-side user B does not respond to the notification (“No” in S304), the operation undergoes transition to S311.

If response denial of the receiving-side user B is not detected by the sensor unit 120B (“No” in S311), the operation undergoes transition to S321. Then, if end of notification of the transmitting-side user is received by the communication unit 140B and is acquired by the transmitting-side user-action-state acquisition unit 114B (“Yes” in S321), the operation ends. If the end of notification of the transmitting-side user is not received by the communication unit 140B and is not acquired by the transmitting-side user-action-state acquisition unit 114B (“No” in S321), the operation undergoes transition to S301.

If the response denial of the receiving-side user B is detected by the sensor unit 120B and is acquired by the receiving-side user-action-state acquisition unit 111B (“Yes” in S311), the response denial is transmitted to the transmitting-side terminal 10A, and the operation undergoes transition to S312. Note that the response denial may be detected in any way. For example, the response denial may be detected by detecting the fact that the user B has removed his/her line of sight from the avatar A, may be detected by detecting the fact that the user B has initiated a particular action other than the communication with the user A, or may be detected by detecting an explicit operation that he/she cannot respond.

Moreover, a denial level may be transmitted together with the response denial. The denial level may be input in any way by the user B. For example, the denial level may be input by an operation (for example, a button operation or the like) by the user B, may be input by voice (for example, particular voice such as “I can't respond”) spoken by the user B, or may be input by a gesture (for example, a particular operation that interrupts the notification) by the user B.

If acceptance by the transmitting-side user A with respect to the response denial by the receiving-side user B is received by the communication unit 140B (“Yes” in S312), the operation ends. On the other hand, if the acceptance by the transmitting-side user A with respect to the response denial by the receiving-side user B is not received by the communication unit 140B (“No” in S312), the operation undergoes transition to S313.

If the disapproval by the transmitting-side user A with respect to the response denial by the receiving-side user B is received by the communication unit 140B (“Yes” in S313), the operation undergoes transition to S301. On the other hand, if the disapproval by the transmitting-side user A with respect to the response denial by the receiving-side user B is not received by the communication unit 140B (“No” in S313), the operation ends.

Hereinabove, the operation example of the receiving-side terminal 10B has been described.

### 3. HARDWARE CONFIGURATION EXAMPLE

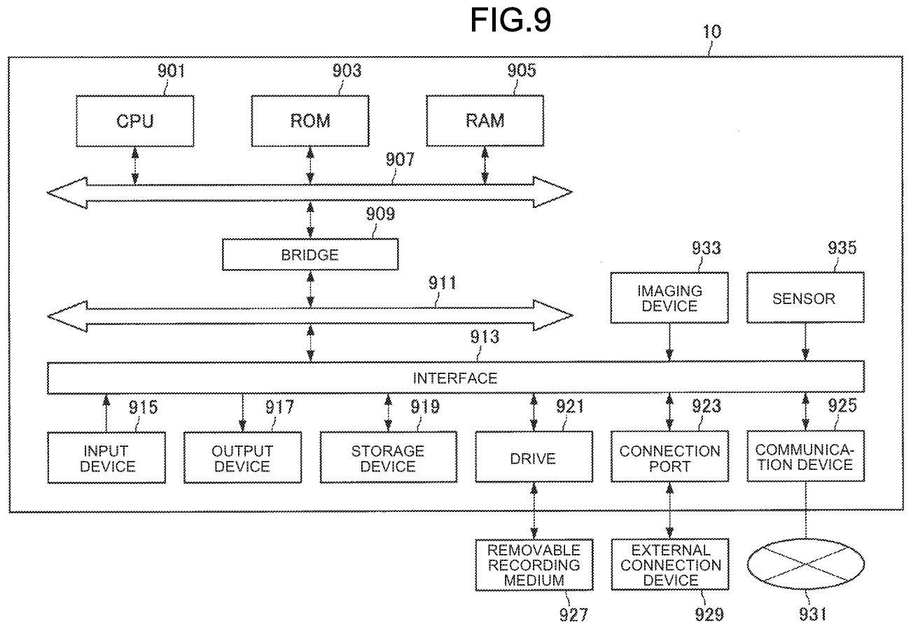

Next, with reference to FIG. 9, a hardware configuration of an information processing device 10 according to the embodiment of the present disclosure (the transmitting-side terminal 10A and the receiving-side terminal 10B) will be described. FIG. 9 is a block diagram illustrating a hardware configuration example of the information processing device 10 according to the embodiment of the present disclosure.

As illustrated in FIG. 9, the information processing device 10 includes a central processing unit (CPU) 901, a read only memory (ROM) 903, and a random access memory (RAM) 905. Moreover, the information processing device 10 includes a host bus 907, a bridge 909, an external bus 911, an interface 913, an input device 915, an output device 917, a storage device 919, a drive 921, a connection port 923, and a communication device 925. Furthermore, the information processing device 10 includes an imaging device 933 and a sensor 935. The information processing device 10 may have a processing circuit called digital signal processor (DSP) or application specific integrated circuit (ASIC) instead of or in addition to the CPU 901.

The CPU 901 functions as an arithmetic processing device and a control device, and controls the entirety or part of operation within the information processing device 10 in accordance with various programs recorded in the ROM 903, the RAM 905, the storage device 919, or a removable recording medium 927. The ROM 903 stores programs, arithmetic parameters, etc. used by the CPU 901. The RAM 905 temporarily stores a program used for execution by the CPU 901, parameters suitably varied during the execution, etc. The CPU 901, the ROM 903, and the RAM 905 are mutually connected through the host bus 907 composed of an internal bus such as a CPU bus. Furthermore, the host bus 907 is connected to the external bus 911 such as a peripheral component interconnect/interface (PCI) bus via the bridge 909.

The input device 915 is a device operable by the user such as a mouse, a keyboard, a touch panel, a button, a switch, a lever, etc. The input device 915 may include a microphone that detects voice of the user. The input device 915 may be, for example, a remote-controlled device making use of infrared radiation or other electric waves, or the input device may be external connection equipment 929 such as a mobile phone supporting operations of the information processing device 10. The input device 915 includes an input control circuit that generates an input signal based on the information input by the user and outputs the signal to the CPU 901. The user operates the input device 915 to input various data into the information processing device 10 or to give instructions for processing operations.

The output device 917 includes a device that can visually or audibly notify the user of acquired information. The output device 917 may be, for example, any of display devices such as a liquid crystal display (LCD), a plasma display panel (PDP), and an organic electro-luminescence (EL) display; display devices such as a projector; a holographic display device; sound output devices such as a speaker and a headphone; and a printer apparatus. The output device 917 outputs results, which are obtained after processing by the information processing device 10, in the form of picture that includes texts, images, or the like or in the form of sound that includes voice, audio data, or the like. Also, the output device 917 may include a light such as a light-emitting diode (LED).

The storage device 919 is a device for storing data built as an exemplary storage unit of the information processing device 10. The storage device 919 includes, for example, a magnetic storage-unit device such as hard disk drive (HDD), a semiconductor storage device, an optical storage device, a magneto-optical storage device, or the like. The storage device 919 stores programs to be executed by the CPU 901, various data, various data acquired from outside, and so on.

The drive 921 is a reader/writer for the removable recording medium 927 such as a magnetic disk, an optical disk, a magneto-optical disk, or a semiconductor memory, and the drive is built in or externally attached to the information processing device 10. The drive 921 reads the information recorded in the attached removable recording medium 927 and outputs the information to the RAM 905. In addition, the drive 921 writes records in the attached removable recording medium 927.

The connection port 923 is a port for directly connecting equipment to the information processing device 10. The connection port 923 can be, for example, a universal serial bus (USB) port, an IEEE1394 port, a small computer system interface (SCSI) port, or the like. Also, the connection port 923 may be an RS-232C port, an optical audio terminal, a high-definition multimedia interface (HDMI) (registered trademark) port, or the like. Various data can be exchanged between the information processing device 10 and the external connection equipment 929 by connecting the external connection equipment 929 to the connection port 923.

The communication device 925 is, for example, a communication interface including a communication device for establishing connection to a communication network 931. The communication device 925 can be, for example, a communication card for wired or wireless local area network (LAN), Bluetooth (registered trademark), or wireless USB (WUSB). Also, the communication device 925 may be a router for optical communication, a router for asymmetric digital subscriber line (ADSL), a modem for various types of communication, or the like. The communication device 925 transmits and receives, for example, signals and the like to and from the Internet and other communication equipment by using a predetermined protocol such as TCP/IP. Also, the communication network 931 connected to the communication device 925 is a wire-connected or wirelessly connected network, such as, the internet, a domestic LAN, an infrared communications network, a radio wave communications, or satellite communications network.

The imaging device 933 is a device that captures a real space and generates a captured image by using various members such as an imaging element such as a charge coupled device (CCD) or complementary metal oxide semiconductor (CMOS) and a lens for controlling the formation of a subject image on the imaging element, for example. The imaging device 933 may capture a still image or may capture a moving image.

The sensor 935 includes, for example, various sensors such as a distance measuring sensor, an acceleration sensor, a gyroscope sensor, a geomagnetic sensor, a vibration sensor, an optical sensor, and a sound sensor. The sensor 935 acquires, for example, information about the state of the information processing device 10 per se such as the disposition of a housing of the information processing device 10; and information about a peripheral environment of the information processing device 10 such as brightness or noise around the information processing device 10. Also, the sensor 935 may include a global positioning system (GPS) sensor that receives a GPS signal and measures the latitude, longitude, and altitude of the device.

### 4. CONCLUSION

As described above, according to the embodiment of the present disclosure, provided is an information processing device including: a first action-state acquisition unit configured to acquire first action-state information about an action state of a first user present at a first location; a second action-state acquisition unit configured to acquire a second action-state information about an action state of a second user present at a second location; an avatar control unit configured to gradually change, in accordance with the action state of the first user, a first avatar representing the first user, the first avatar being provided so as to be visible to the second user at the second location; an input determination unit configured to determine input about the first avatar based on the second action-state information; and a transmission unit configured to transmit a signal to a terminal of the first user present at the first location based on the input about the first avatar.

According to such a configuration, the user of the notification receiving side or the user of the notification transmitting side can easily understand the situation of his/her counterpart.

### 5. MODIFICATION EXAMPLE

Hereinabove, the preferred embodiment of the present disclosure has been described in detail with reference to the accompanying drawings, but the technical scope of the present disclosure is not limited to such examples. It will be apparent to those skilled in the art of the present disclosure that various modifications and alterations can be conceived within the scope of the technical idea described in the claims and naturally fall within the technical scope of the present disclosure.

For example, a program for causing hardware such as a CPU, a ROM, and a RAM built in a computer to exert the functions equivalent to the functions of the above described control unit 110A can be also created. Also, a computer-readable recording medium recording the program can be also provided. Also, for example, a program for causing hardware such as a CPU, a ROM, and a RAM built in a computer to exert the functions equivalent to the functions of the above described control unit 110B can be also created. Also, a computer-readable recording medium recording the program can be also provided.

The above description has mainly described about the case in which the transmitting-side user-action-state acquisition unit 111A, the input determination unit 112A, the transmission unit 113A, the receiving-side user-action-state acquisition unit 114A, and the avatar control unit 115A are built in the transmitting-side terminal 10A. However, part of these functions may be built in a device different from the transmitting-side terminal 10A. For example, the input determination unit 112A may be built in a device (for example, a server) different from the transmitting-side terminal 10A.

The above description has mainly described about the case in which the receiving-side user-action-state acquisition unit 111B, the input determination unit 112B, the transmission unit 113B, the transmitting-side user-action-state acquisition unit 114B, and the avatar control unit 115B are built in the receiving-side terminal 10B. However, part of these functions may be built in a device different from the receiving-side terminal 10B. For example, the input determination unit 112B may be built in a device (for example, a server) different from the receiving-side terminal 10B.

The above description has mainly described about the case in which the avatar is provided so as to be visible to the user. On the other hand, the presence of the avatar may be presented to the user by using an output device capable of carrying out so-called sound localization instead of using visible information. In other words, the avatar may be considered as an agent which is localized at any position of space, and the method to present the avatar to the user is not limited to display control. As an output device which carries out such sound localization, an open speaker which localizes the sound image of the avatar in the space based on a head-related transfer function (HRTF) may be used.

Furthermore, the effects described in the present specification are only descriptive or exemplary and are not limitative. That is, the technology according to the present disclosure can exhibit other effects apparent to those skilled in the art from the description of the present specification in addition to or instead of the above described effects.

Note that the following configurations also fall within the technical scope of the present disclosure.

(1)

An information processing device comprising:

a first action-state acquisition unit configured to acquire first action-state information about an action state of a first user present at a first location;

a second action-state acquisition unit configured to acquire a second action-state information about an action state of a second user present at a second location;

an avatar control unit configured to gradually change, in accordance with the action state of the first user, a first avatar representing the first user, the first avatar being provided so as to be visible to the second user at the second location;

an input determination unit configured to determine input about the first avatar based on the second action-state information; and

a transmission unit configured to transmit a signal to a terminal of the first user present at the first location based on the input about the first avatar.

(2)

The information processing device according to (1), wherein

the input about the first avatar includes at least one of first input or second input, and

the transmission unit

transmits a first signal indicating initiation of communication to the terminal of the first user based on the first input, and

transmits a second signal indicating non-permission of initiation of communication to the terminal of the first user based on the second input.

(3)

The information processing device according to (2), wherein, if a communication permission notification based on the first action-state information is continuously transmitted around time when the transmission unit transmits the second signal, the avatar control unit changes a state of the first avatar to a state indicating a re-notification from the first user.

(4)

The information processing device according to (2) or (3), wherein the first input is relatively-intentional input made by the second user compared with the second input.

(5)

The information processing device according to (4), further comprising

an input determination unit configured to determine the first input and the second input based on image information or depth information of the second user, wherein

the first input includes information about a particular gesture, and

the second input does not include the information about the particular gesture.

(6)

The information processing device according to (5), wherein the particular gesture is a gesture that a hand of the second user gets close to a face of the second user.

(7)

The information processing device according to (4), further comprising an input determination unit configured to determine the first input based on voice information of the second user and determine the second input based on image information or depth information of the second user.

(8)

The information processing device according to any one of (4) to (7), wherein the input determination unit determines, as the second input, a fact that the second user has recognized a change of the first avatar based on image information or depth information of the second user.

(9)

The information processing device according to any one of (1) to (8), wherein the avatar control unit initiates changing display of the first avatar in response to a permission request about initiation of communication with the second user, the permission request being transmitted from the terminal of the first user.

(10)

The information processing device according to (9), further comprising a communication unit configured to establish communication between the information processing device and the terminal of the first user via a network in response to the transmission of the signal to the terminal of the first user.

(11)

The information processing device according to any one of (1) to (10), wherein the transmission unit transmits a signal indicating the action state of the second user to the terminal of the first user.

(12)

The information processing device according to (11), wherein the transmission unit changes the signal indicating the action state of the second user based on the input about the first avatar.

(13)

The information processing device according to (12), wherein the transmission unit transmits a signal that controls an avatar controlled by the terminal of the first user and representing the second user.

(14)

The information processing device according to any one of (1) to (13), further comprising a display device configured to display the first avatar.

(15)

The information processing device according to any one of (1) to (13), wherein the first avatar is a mobile object having a drive mechanism.

(16)

An information processing method comprising:

acquiring first action-state information about an action state of a first user present at a first location;

acquiring a second action-state information about an action state of a second user present at a second location;

gradually changing, in accordance with the action state of the first user, a first avatar representing the first user, the first avatar being provided so as to be visible to the second user at the second location;

determining input about the first avatar based on the second action-state information; and

transmitting, by a processor, a signal to a terminal of the first user present at the first location based on the input about the first avatar.

(18)

A program for causing a computer to function as

an information processing device comprising:

a first action-state acquisition unit configured to acquire first action-state information about an action state of a first user present at a first location;

a second action-state acquisition unit configured to acquire a second action-state information about an action state of a second user present at a second location;

an avatar control unit configured to gradually change, in accordance with the action state of the first user, a first avatar representing the first user, the first avatar being provided so as to be visible to the second user at the second location;

an input determination unit configured to determine input about the first avatar based on the second action-state information; and

a transmission unit configured to transmit a signal to a terminal of the first user present at the first location based on the input about the first avatar.

### REFERENCE SIGNS LIST

1 INFORMATION PROCESSING SYSTEM
10A TRANSMITTING-SIDE TERMINAL (INFORMATION PROCESSING DEVICE)
110A CONTROL UNIT
111A TRANSMITTING-SIDE USER-ACTION-STATE ACQUISITION UNIT
112A INPUT DETERMINATION UNIT
113A TRANSMISSION UNIT
114A RECEIVING-SIDE USER-ACTION-STATE ACQUISITION UNIT
115A AVATAR CONTROL UNIT
120A SENSOR UNIT
140A COMMUNICATION UNIT
150A STORAGE UNIT
160A PRESENTATION UNIT
10B RECEIVING-SIDE TERMINAL (INFORMATION PROCESSING DEVICE)
110B CONTROL UNIT
111B RECEIVING-SIDE USER-ACTION-STATE ACQUISITION UNIT
112B INPUT DETERMINATION UNIT
113B TRANSMISSION UNIT
114B TRANSMITTING-SIDE USER-ACTION-STATE ACQUISITION UNIT
115B AVATAR CONTROL UNIT
120B SENSOR UNIT
140B COMMUNICATION UNIT
150B STORAGE UNIT
160B PRESENTATION UNIT

1. An information processing device comprising:
a first action-state acquisition unit configured to acquire first action-state information about an action state of a first user present at a first location;
a second action-state acquisition unit configured to acquire a second action-state information about an action state of a second user present at a second location;
an avatar control unit configured to gradually change, in accordance with the action state of the first user, a first avatar representing the first user, the first avatar being provided so as to be visible to the second user at the second location;
an input determination unit configured to determine input about the first avatar based on the second action-state information; and
a transmission unit configured to transmit a signal to a terminal of the first user present at the first location based on the input about the first avatar.

2. The information processing device according to claim 1, wherein
the input about the first avatar includes at least one of first input or second input, and
the transmission unit
transmits a first signal indicating initiation of communication to the terminal of the first user based on the first input, and
transmits a second signal indicating non-permission of initiation of communication to the terminal of the first user based on the second input.

3. The information processing device according to claim 2, wherein, if a communication permission notification based on the first action-state information is continuously transmitted around time when the transmission unit transmits the second signal, the avatar control unit changes a state of the first avatar to a state indicating a re-notification from the first user.

4. The information processing device according to claim 2, wherein the first input is relatively-intentional input made by the second user compared with the second input.

5. The information processing device according to claim 4, further comprising
an input determination unit configured to determine the first input and the second input based on image information or depth information of the second user, wherein
the first input includes information about a particular gesture, and
the second input does not include the information about the particular gesture.

6. The information processing device according to claim 5, wherein the particular gesture is a gesture that a hand of the second user gets close to a face of the second user.

7. The information processing device according to claim 4, further comprising an input determination unit configured to determine the first input based on voice information of the second user and determine the second input based on image information or depth information of the second user.

8. The information processing device according to claim 4, wherein the input determination unit determines, as the second input, a fact that the second user has recognized a change of the first avatar based on image information or depth information of the second user.

9. The information processing device according to claim 1, wherein the avatar control unit initiates changing display of the first avatar in response to a permission request about initiation of communication with the second user, the permission request being transmitted from the terminal of the first user.

10. The information processing device according to claim 9, further comprising a communication unit configured to establish communication between the information processing device and the terminal of the first user via a network in response to the transmission of the signal to the terminal of the first user.

11. The information processing device according to claim 1, wherein the transmission unit transmits a signal indicating the action state of the second user to the terminal of the first user.

12. The information processing device according to claim 11, wherein the transmission unit changes the signal indicating the action state of the second user based on the input about the first avatar.

13. The information processing device according to claim 12, wherein the transmission unit transmits a signal that controls an avatar controlled by the terminal of the first user and representing the second user.

14. The information processing device according to claim 1, further comprising a display device configured to display the first avatar.

15. The information processing device according to claim 1, wherein the first avatar is a mobile object having a drive mechanism.

16. An information processing method comprising:
acquiring first action-state information about an action state of a first user present at a first location;
acquiring a second action-state information about an action state of a second user present at a second location;
gradually changing, in accordance with the action state of the first user, a first avatar representing the first user, the first avatar being provided so as to be visible to the second user at the second location;
determining input about the first avatar based on the second action-state information; and
transmitting, by a processor, a signal to a terminal of the first user present at the first location based on the input about the first avatar.

17. A program for causing a computer to function as
an information processing device comprising:
a first action-state acquisition unit configured to acquire first action-state information about an action state of a first user present at a first location;
a second action-state acquisition unit configured to acquire a second action-state information about an action state of a second user present at a second location;
an avatar control unit configured to gradually change, in accordance with the action state of the first user, a first avatar representing the first user, the first avatar being provided so as to be visible to the second user at the second location;
an input determination unit configured to determine input about the first avatar based on the second action-state information; and
a transmission unit configured to transmit a signal to a terminal of the first user present at the first location based on the input about the first avatar.
